(19) United States
(12) Patent Application Publication
(10) Pub. No.: US 2023/0278541 A1
(43) Pub. Date: Sep. 7, 2023

(54) BRAKING DEVICE FOR VEHICLE

(71) Applicant: DENSO CORPORATION, Kariya-city (JP)

(72) Inventor: YUSUKE SHIBATA, Kariya-city (JP)

(21) Appl. No.: 18/315,732

(22) Filed: May 11, 2023

Related U.S. Application Data
(63) Continuation of application No. PCT/JP2021/040483, filed on Nov. 4, 2021.

(30) Foreign Application Priority Data
Nov. 16, 2020 (JP) 2020-190288

(51) Int. Cl. B60W 30/02; B60W 30/18; B60W 10/192; B60W 10/20; B60L 7/26; B60K 7/00; B60W 10/08

(52) U.S. Cl. CPC B60W 30/02; B60W 30/18109; B60W 10/192; B60W 10/20; B60L 7/26; B60K 7/0007; B60W 30/18127; B60W 10/08; B60W 2710/18; B60W 2710/20; B60W 2720/14; B60W 2510/18; B60W 2710/083

(57) ABSTRACT

A braking device is mounted on a vehicle having two or more rows of right and left wheels, electric brakes, and at least one steering actuator. The steering actuator is capable of turning at least one row of the right and left wheels regardless of a steering wheel operation. The braking device includes a braking control unit configured to control a braking force of the electric brake for each of the wheels and operation of the steering actuator. When an abnormality detector detects an abnormality in the electric brakes, the braking control unit switches to an abnormal-time braking control different from a normal state control, at least controlling the steering actuator so as to suppress an influence on the vehicle due to the abnormality.

### CROSS REFERENCE TO RELATED APPLICATIONS

The present application is a continuation application of International Patent Application No. PCT/JP2021/040483 filed on Nov. 4, 2021, which designated the U.S. and claims the benefit of priority from Japanese Patent Application No. 2020-190288 filed on Nov. 16, 2020. The entire disclosures of all of the above applications are incorporated herein by reference.

### TECHNICAL FIELD

The present disclosure relates to a braking device for a vehicle.

### BACKGROUND

Conventionally, there is known a technique of stopping and parking a vehicle when an electric brake corresponding to one of wheels of the vehicle is abnormal.

### SUMMARY

According to an aspect of the present disclosure, a braking device is mounted on a vehicle having two or more rows of right and left wheels, plural electric brakes and at least one steering actuator. The electric brake generates a braking force on each wheel. The steering actuator is capable of turning at least one row of right and left wheels regardless of a steering wheel operation. The braking device includes: a braking control unit configured to control a braking force for each wheel, which includes a braking force of the electric brake, and an operation of the steering actuator; and an abnormality detector configured to detect an abnormality in the electric brake. When the abnormality detector detects an abnormality in the electric brakes, the braking control unit switches to an abnormal-time braking control different from a normal control, to control at least the steering actuator, so as to suppress an influence on the vehicle due to the abnormality.

### BRIEF DESCRIPTION OF DRAWINGS

FIG. 1 is a configuration diagram illustrating a braking device according to a first embodiment mounted in a front two-wheel non-independently steered vehicle.

FIG. 2 is a schematic diagram illustrating a braking force in a normal state.

FIG. 3 is a schematic diagram illustrating a braking force and a yaw moment at a braking abnormal time.

FIG. 4 is a schematic diagram illustrating adjustment of a braking force in a comparative example.

FIG. 5 is a schematic diagram illustrating an abnormal-time braking control according to the first embodiment.

FIG. 6A is a diagram illustrating a relationship between a steering angle and a yaw moment in a yaw moment compensation steering control.

FIG. 6B is a diagram illustrating a relationship between a steering angle and a braking force generated by steering.

FIG. 7 is a flowchart of an abnormal-time braking control according to the first embodiment.

FIG. 8 is a diagram illustrating distribution of a required braking force to each wheel in response to a required deceleration.

FIG. 9 is a configuration diagram illustrating a braking device according to a second embodiment, which is mounted in a front two-wheel non-independently driven vehicle.

FIG. 10 is a flowchart of an abnormal-time braking control according to the second embodiment.

FIG. 11 is a diagram illustrating a use of a regenerative braking force.

FIG. 12 is a diagram illustrating a change in distribution of a required braking force.

FIG. 13 is a configuration diagram illustrating a braking device according to a third embodiment, which is mounted in a front two-wheel independently driven vehicle.

FIG. 14 is a schematic diagram illustrating a braking force by a wheel drive motor in a front two-wheel non-independently driven vehicle in the second embodiment as a comparative example of the third embodiment.

FIG. 15 is a schematic diagram illustrating a braking force by a wheel drive motor in a front two-wheel independently driven vehicle according to the third embodiment.

FIG. 16 is a configuration diagram illustrating a braking device according to a fourth embodiment, which is mounted in a four-wheel independently driven vehicle.

FIG. 17 is a configuration diagram illustrating a braking device according to a fifth embodiment, which is mounted in a front two-wheel independently steered vehicle.

FIG. 18 is a schematic diagram illustrating an abnormal-time braking control in the front two-wheel independently steered vehicle according to the fifth embodiment.

FIG. 19 is a schematic diagram illustrating an abnormal-time braking control in the front two-wheel independently steered vehicle according to the fifth embodiment.

FIG. 20 is a configuration diagram illustrating a braking device according to a sixth embodiment, which is mounted in a four-wheel independently steered vehicle.

FIG. 21 is a schematic diagram illustrating an abnormal-time braking control in the first embodiment as a comparative example of the sixth embodiment.

FIG. 22 is a schematic diagram illustrating an abnormal-time braking control in a four-wheel independently steered vehicle according to the sixth embodiment.

FIG. 23 is a schematic diagram illustrating an abnormal-time braking control in a four-wheel independently steered vehicle according to the sixth embodiment.

FIG. 24 is a schematic diagram illustrating an abnormal-time braking control in a four-wheel independently steered vehicle according to the sixth embodiment.

FIG. 25 is a schematic diagram illustrating an abnormal-time braking control in a four-wheel independently steered vehicle according to the sixth embodiment.

FIG. 26 is a schematic diagram illustrating an abnormal-time braking control in a four-wheel independently steered vehicle according to the sixth embodiment.

### DETAILED DESCRIPTION

Conventionally, there is known a technique of stopping and parking a vehicle when an electric brake corresponding to one of wheels of the vehicle is abnormal. For example, a vehicle is stopped and parked by transmission connection, toe angle control, regenerative braking, counter torque generation, or the like when an electric brake fails.

Conventionally, right and left wheels are symmetrically toed in or toed out by toe angle control with respect to steering of the wheels when the electric brake fails, without an idea of turning the right and left wheels so as to be asymmetrical. Further, in the related art, for example, when an electric brake for a front left wheel fails, if a braking force for a normal front right wheel is reduced in the same manner, the braking force for the normal wheel cannot be sufficiently utilized. Furthermore, the vehicle may be affected by generation of an unnecessary yaw moment caused by a difference in braking force between the right and left wheels.

The present disclosure provides a braking device capable of braking a vehicle so as to suppress an influence on behavior of the vehicle when an electric brake is abnormal.

A braking device according to the present disclosure is mounted on a vehicle having two or more rows of right and left wheels in a front-rear direction, plural electric brakes and at least one steering actuator. The electric brake generates a braking force on each wheel. The steering actuator is capable of turning at least one row of right and left wheels regardless of a steering wheel operation.

The braking device includes: a braking control unit configured to control a braking force for each wheel, which includes a braking force of the electric brake, and an operation of the steering actuator; and an abnormality detector configured to detect an abnormality in the electric brake. When the abnormality detector detects an abnormality in the electric brakes, the braking control unit switches to an abnormal-time braking control different from a normal control, to control at least the steering actuator, so as to suppress an influence on the vehicle behavior due to the abnormality.

The braking control unit of the present disclosure is capable of controlling the operation of the steering actuator, and performs the abnormal-time braking control including at least the control of the steering actuator when the electric brake is abnormal. Thus, the braking device is able to brake the vehicle by turning the wheel so as to suppress the influence on the vehicle behavior.

One of the right and left wheels corresponding to the electric brake in which the abnormality is detected is referred to as an abnormal-braking wheel, and the other wheel corresponding to the electric brake which is normal is referred to as a conjugate normal wheel. For example, when the front left wheel becomes abnormal, if the braking force is applied only to the front right wheel which is the conjugate normal wheel, an unnecessary yaw moment is generated in the rightward rotational direction.

Therefore, preferably, in the abnormal-time braking control, the braking control unit drives one of the steering actuators so as to reduce a difference between an actual yaw moment generated by a difference in braking force between the abnormal-braking wheel and the conjugate normal wheel and a required yaw moment required for the vehicle.

Hereinafter, a braking device for a vehicle according to an embodiment will be described with reference to the drawings. The braking device of the present embodiment performs an abnormal-time braking control different from a normal control when an electric brake provided corresponding to each wheel is abnormal. The braking device is mounted on a vehicle including at least one steering actuator capable of turning at least one pair of right and left wheels regardless of a steering wheel operation. The abnormal-time braking control includes at least control of the steering actuator. Hereinafter, in the following embodiments, substantially the same components are denoted by the same reference numerals, and description thereof will be omitted.

### First Embodiment

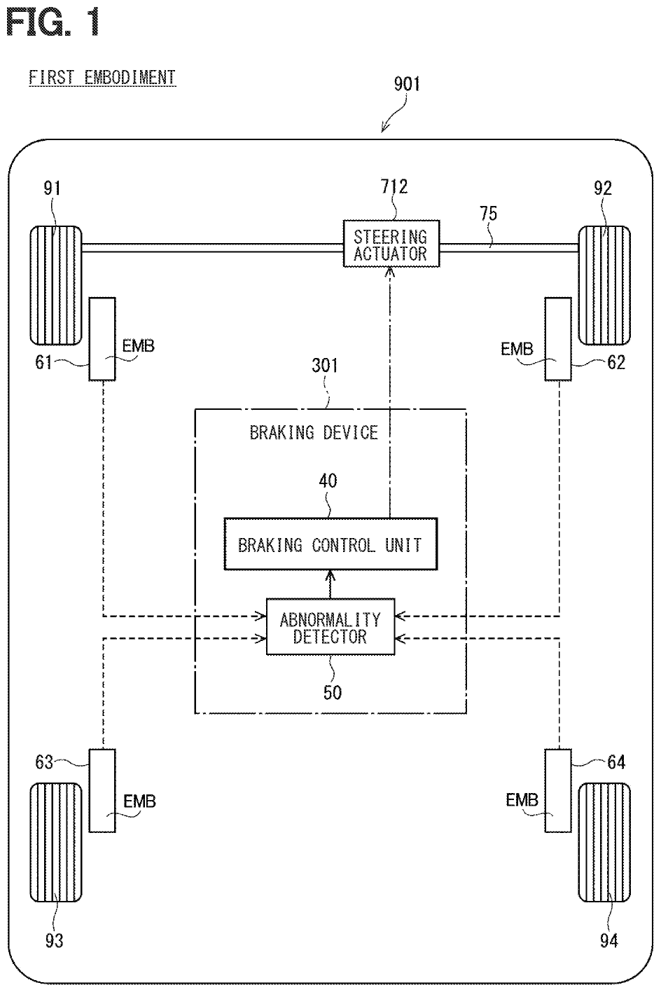

A first embodiment will be described with reference to FIGS. 1 to 8. A vehicle 901 on which a vehicle braking device 301 of the first embodiment is mounted is a four-wheel vehicle having two rows of right and left wheels 91, 92, 93, 94 in the vehicle front-rear direction. Hereinafter, the front left wheel is referred to as an FL wheel 91, the front right wheel is referred to as an FR wheel 92, the rear left wheel is referred to as an RL wheel 93, and the rear right wheel is referred to as an RR wheel 94.

Hereinafter, except for the reference numerals of the vehicle and the vehicle braking device, the reference numerals of devices and physical quantities corresponding to the wheels 91, 92, 93, 94 are appended with the same numerals as the end numerals of the reference numerals of the wheels. For example, the number “1” at the end of the reference numeral corresponds to the FL wheel 91. Similarly, the number “2” corresponds to the FR wheel 92, the number “3” corresponds to the RL wheel 93, and the number “4” corresponds to the RR wheel 94.

The vehicle 901 includes plural electric brakes 61, 62, 63, 64 to generate braking forces on the wheels 91, 92, 93, 94, respectively, and one steering actuator 712. In the drawings, the electric brake is referred to as “EMB”. The electric brake 61, 62, 63, 64 is supplied with electric power from, for example, a three-phase inverter (not illustrated), and perform braking and releasing operations.

The steering actuator 712 can turn the front wheel 91, 92 regardless of the steering wheel operation. In the first embodiment, the steering actuator 712 collectively turns the FL wheel 91 and the FR wheel 92 via the rack bar 75. That is, the first embodiment is for a configuration of “front two-wheel non-independently steered vehicle”.

The vehicle braking device 301 includes a braking control unit 40 and an abnormality detector 50. The braking control unit 40 can control the braking force for each wheel, including the braking force of the electric brake 61, 62, 63, 64 and the operation of the steering actuator 712. The abnormality detector 50 detects an abnormality in the electric brakes 61, 62, 63, 64.

For example, when the electric brake 61, 62, 63, 64 is driven by three-phase electric power, the abnormality detector 50 may use abnormality detection such as inverter upstream voltage abnormality or three-phase current abnormality, or may perform determination from a load sensor, a wheel speed sensor, or the like. In addition to the failure of the electric brake 61, 62, 63, 64, a decrease in braking force may be included as an abnormality due to an output limitation or the like at the time of overheating.

When the abnormality detector 50 detects an abnormality in any one of the electric brakes, the braking control unit 40 switches to an abnormal-time braking control different from a normal state control, which includes at least control of the steering actuator 712 so as to suppress an influence on the vehicle behavior due to the abnormality. Hereinafter, the significance and method of the abnormal-time braking control will be described in detail.

Strictly speaking, an abnormality occurs in the electric brake, and the wheel itself does not become abnormal. However, for convenience of description, a wheel in which the corresponding electric brake is abnormal is referred to as an abnormal braking wheel or simply as an abnormal wheel, and a wheel in which the corresponding electric brake is normal is referred to as a normal wheel. When one of the right and left wheels is the abnormal braking wheel, the other wheel in which the corresponding electric brake is normal is referred to as a conjugate normal wheel. When the FL wheel 91 is the abnormal braking wheel, the FR wheel 92 corresponds to the conjugate normal wheel. In addition, a wheel in which the corresponding electric brake becomes abnormal and the braking function is lost or deteriorated is also referred to as “wheel failure”.

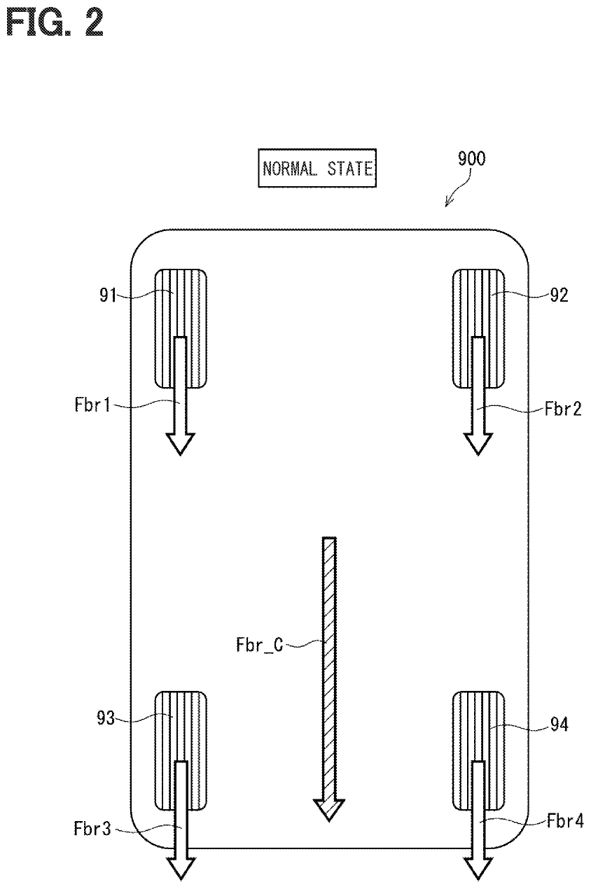

First, the object of the present embodiment will be described with reference to FIGS. 2 to 4. FIG. 2 shows a normal state of the electric brake 61, 62, 63, 64 in the general vehicle 900. The white block arrow indicates the braking force Fbr1, Fbr2, Fbr3, Fbr4 of the wheel 91, 92, 93, 94. The hatched block arrow indicates the vehicle braking force Fbr_C acting on the entire vehicle 900, and the length thereof indicates the magnitude of the vehicle braking force Fbr_C relative to the other drawings.

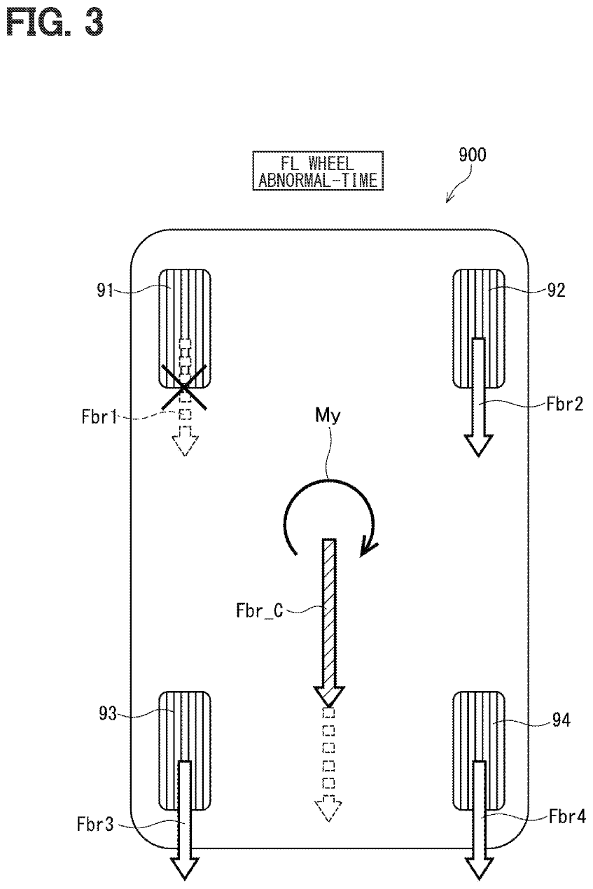

FIG. 3 shows an abnormal state of the FL wheel 91. The mark “x” represents a failure, and the broken block arrow represents the lost braking force. That is, the braking force Fbr1 of the FL wheel 91 is lost, and the vehicle braking force Fbr_C decreases. On the other hand, the normal braking force Fbr2 acts on the FR wheel 92 which is the conjugate normal wheel. Therefore, an unnecessary yaw moment My is generated in the rightward rotational direction due to a difference in braking force between the FL wheel 91, which is the abnormal braking wheel, and the FR wheel 92, which is the conjugate normal wheel.

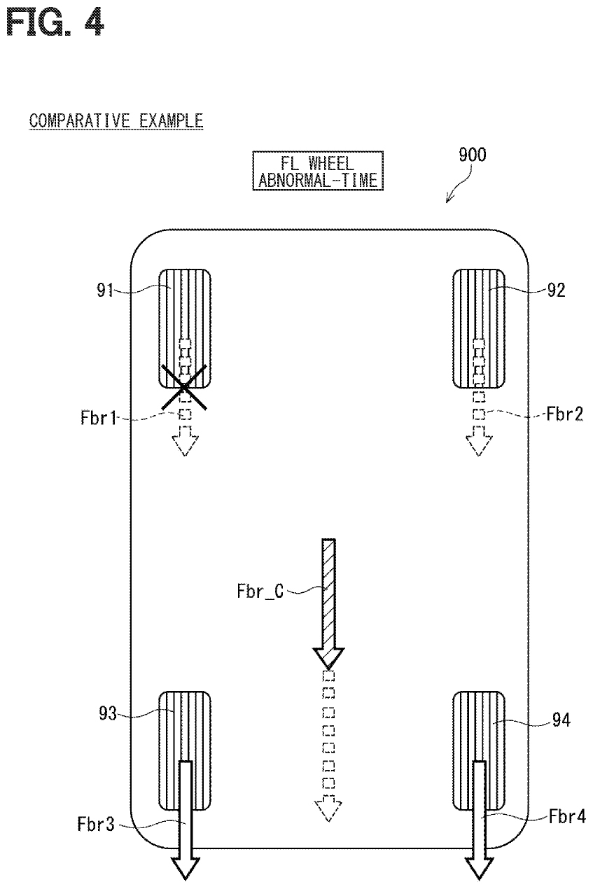

In a comparative example shown in FIG. 4, the generation of the yaw moment is suppressed by reducing the braking force Fbr2 of the FR wheel 92, which is the conjugate normal wheel, so as to adjust the balance in the braking forces between the FL wheel 91 and the FR wheel 92. In this configuration, although the yaw moment is suppressed, the vehicle braking force Fbr_C decreases.

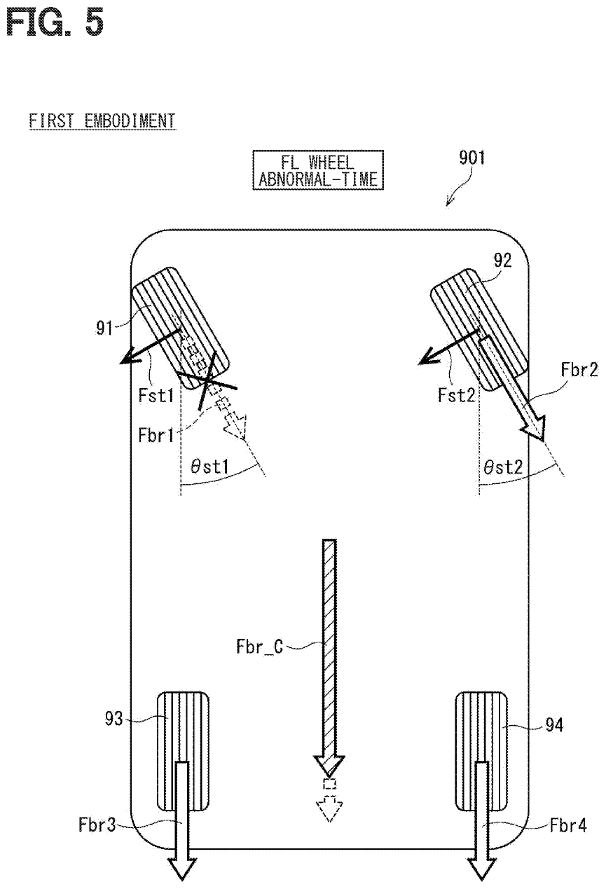

Next, the abnormal-time braking control of the first embodiment will be described with reference to FIGS. 5 to 8. As shown in FIG. 5, in the abnormal-time braking control of the first embodiment, the steering actuator 712 corresponding to the abnormal braking wheel is driven to turn the FL wheel 91 and the FR wheel 92 leftward. A thick arrow Fst1, Fst2 indicates the steering force, and an angle θst1, θst2 indicates the steering angle. Accordingly, the yaw moment can be canceled by the steering angle θst1, θst2 without reducing the braking force Fbr2 of the FR wheel 92. Therefore, the vehicle braking force Fbr_C can be maintained at a value close to that in the normal state. This braking control is referred to as “yaw moment compensation steering control”.

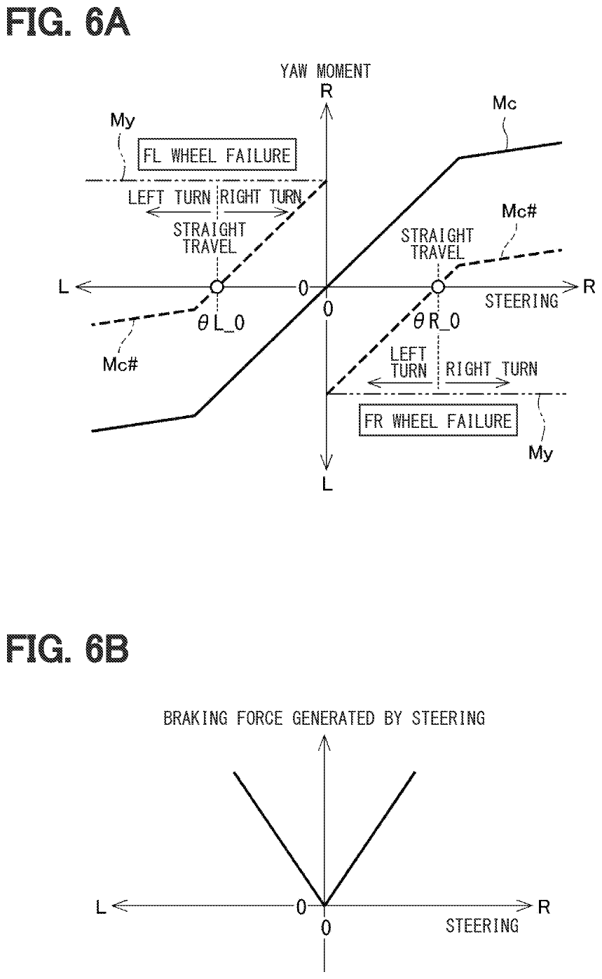

FIG. 6A shows a relationship between the steering angle and the yaw moment in the yaw moment compensation steering control. When the FL wheel 91 fails, as indicated by the two-dot chain line, the yaw moment My is generated in the rightward rotational direction. In order to cancel out the yaw moment My, the front wheels 91 and 92 are steered leftward, as indicated by the solid line, to generate a compensation moment Mc having a positive correlation with the steering angle. The compensated yaw moment Mc #after this compensation is indicated by a broken line. When the vehicle 901 is caused to travel straight, the braking control unit 40 performs the steering control at the steering angle θL_0 at which the compensated yaw moment Mc #becomes 0 as a “required yaw moment required for the vehicle”.

When turning the vehicle 901 to the left, the braking control unit 40 performs the turning control at a steering angle having an absolute value larger than the steering angle θL_0. When turning the vehicle 901 to the right, the braking control unit performs the turning control at a steering angle having an absolute value smaller than the steering angle θL_0. That is, it is possible to respond to the turning request by adjusting the compensated moment by setting the steering angle. Similarly, when the FR wheel 92 fails, the steering angle is set according to the straight travel, the left turn, or the right turn based on the steering angle θR_0 at which the compensated yaw moment Mc #becomes 0. As shown in FIG. 6B, the braking force generated by the steering increases as the absolute value of the steering angle increases.

As described above, in the abnormal-time braking control, the braking control unit 40 drives the steering actuator 712 so as to reduce the difference between the actual yaw moment generated by the difference in braking force between the abnormal braking wheel and the conjugated normal wheel and the required yaw moment required for the vehicle. The required moment at the time of straight travel is 0, and the required moment at the time of turning is a value other than 0.

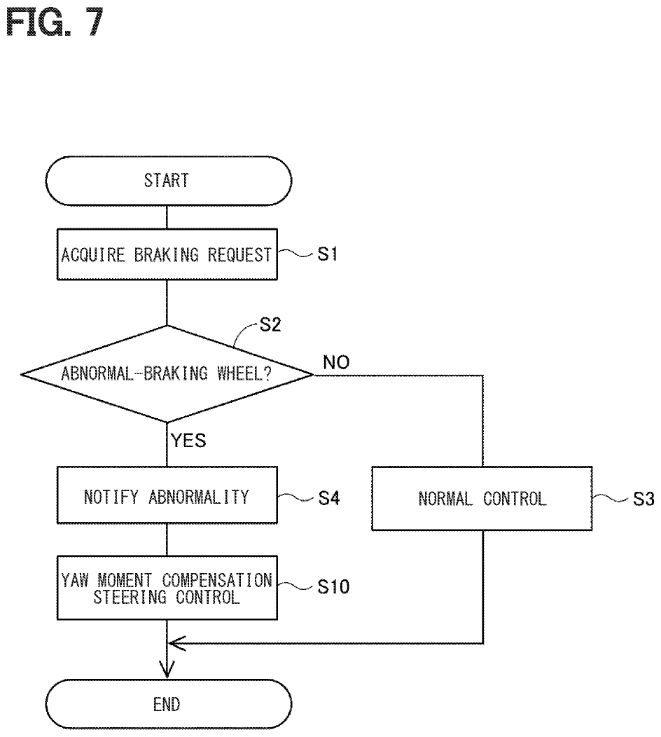

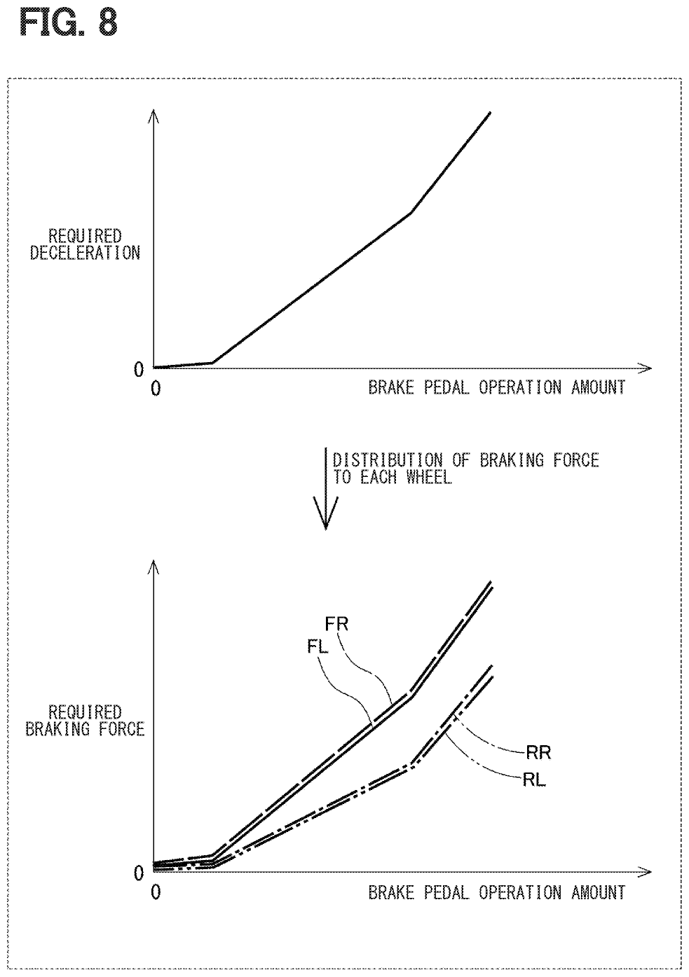

The abnormal-time braking control according to the first embodiment will be described with reference to the flowchart of FIG. 7 and FIG. 8. In the following description of the flowcharts, the symbol “S” means a step. FIG. 8 shows the distribution of the required braking force for each wheel according to the required deceleration. The upper part of FIG. 8 shows a map of the brake pedal operation amount and the required deceleration, and the lower part of FIG. 8 shows a map of the brake pedal operation amount and the required braking force. The upper part and the lower part of FIG. 8 are treated as a set of association diagrams.

In S1, the braking control unit 40 acquires a braking request. The braking control unit 40 calculates the required deceleration using, for example, the map shown in the upper part of FIG. 8 from the signals such as the brake pedal operation amount and the vehicle speed. As shown in the lower part of FIG. 8, the braking control unit 40 distributes the braking force required for the vehicle in total to the wheels 91, 92, 93, 94. The distribution is determined based on, for example, the ratio of the loads of the wheels. It may be reflected that a load is applied to the front wheels as the deceleration increases.

In S2, it is determined whether there is an abnormal braking wheel corresponding to the electric brake in which the abnormality is detected. When there is no abnormal braking wheel (NO in S2), a normal control is performed in S3. When there is an abnormal braking wheel (YES in S2), the braking control unit 40 notifies the abnormality by lighting a lamp or the like in S4. In S10, the braking control unit 40 switches to the abnormal-time braking control different from the normal control so as to suppress the influence on the vehicle behavior. That is, the braking control unit 40 cancels the unnecessary yaw moment by switching to the yaw moment compensation steering control including the control of the steering actuator 712.

As described above, the braking control unit 40 of the first embodiment can control the operation of the steering actuator 712, and performs the “abnormal-time braking control” including at least the control of the steering actuator 712 when the electric brake is abnormal. Accordingly, the vehicle braking device 301 can brake the vehicle by turning the wheels 91, 92 so as to suppress the influence on the vehicle behavior.

### Second Embodiment

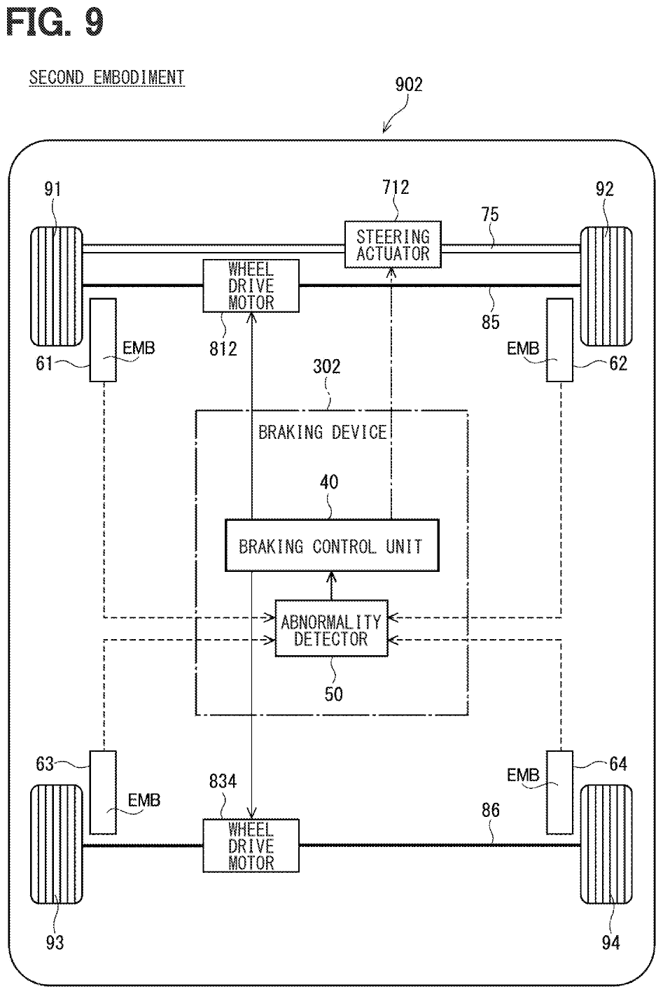

Next, the second embodiment will be described with reference to FIGS. 9 to 12. As shown in FIG. 9, the vehicle 902 on which the vehicle braking device 302 of the second embodiment is mounted includes a wheel drive motor 812 and a wheel drive motor 834 in addition to the steering actuator 712 similar to that of the first embodiment. The wheel drive motor 812 commonly drives the FL wheel 91 and the FR wheel 92 in the front row. The wheel drive motor 834 commonly drives the RL wheel 93 and the RR wheel 94 in the rear row.

The wheel drive motor 812 non-independently drives the FL wheel 91 and the FR wheel 92 via the connection output shaft 85. That is, the second embodiment has a configuration of “front two-wheel non-independently driven vehicle”. The wheel drive motor 834 non-independently drives the RL wheel 93 and the RR wheel 94 via the connection output shaft 86. The braking control unit 40 of the vehicle braking device 302 controls the operation of the steering actuator 712 and the wheel drive motors 812, 834.

Typically, the wheel drive motor 812, 834 drives the wheel 91, 92, 93, 94 in an electric vehicle or a hybrid vehicle. In the abnormal-time braking control, the braking control unit 40 switches energization, so as to generate a regenerative torque or a counter torque, for at least the wheel drive motor corresponding to the abnormal braking wheel, to generate the braking force.

The regenerative torque suppresses rotation of the wheel. The counter torque rotates the wheel in a direction opposite to the traveling direction of the vehicle. In the following description, the braking force generated by the regenerative torque or the counter torque of the wheel drive motor is collectively referred to as a “regenerative braking force”. The maximum value of the regenerative braking force that can be output is set by calculation using the capacity and state of the battery, that is, the maximum current, the remaining battery capacity, and the like.

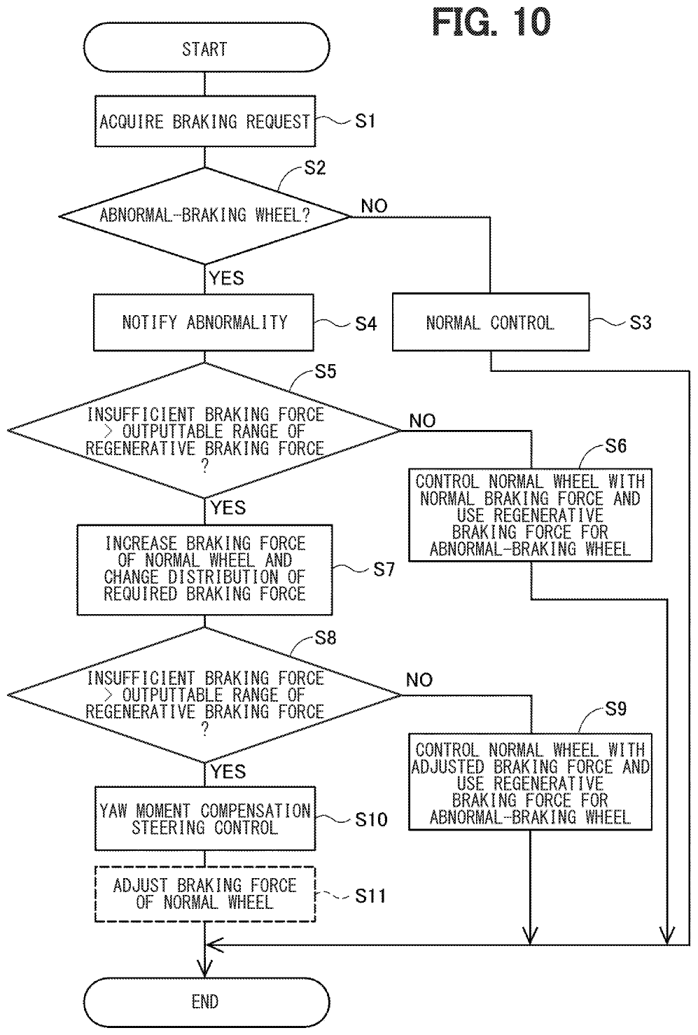

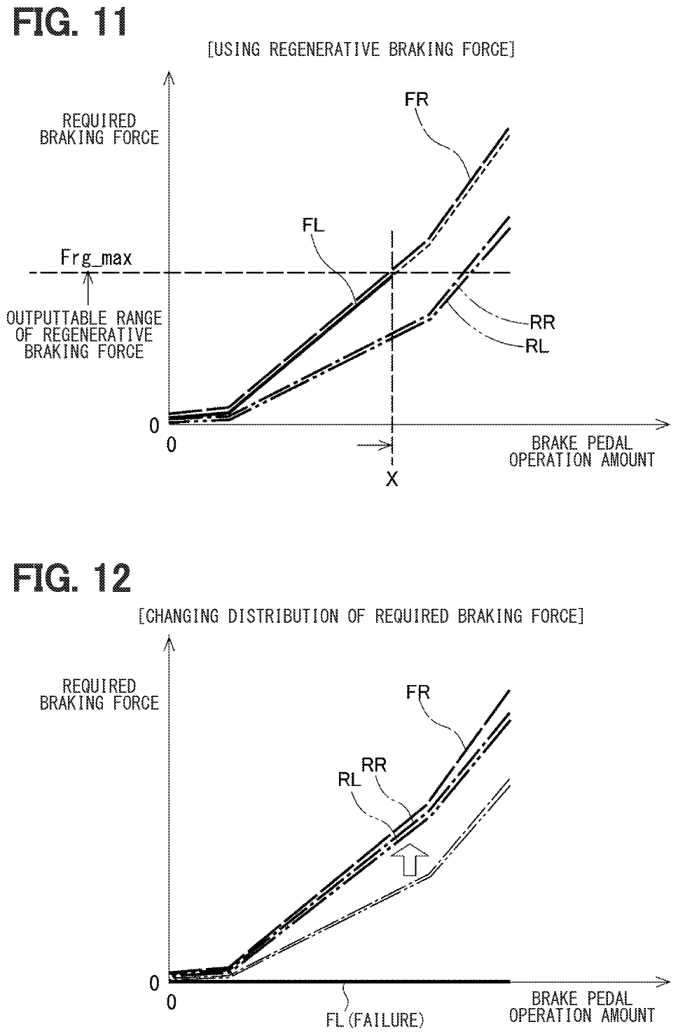

Next, the abnormal-time braking control according to the second embodiment will be described with reference to the flowchart of FIG. 10 and FIGS. 11 and 12. Steps S1 to S4 in FIG. 10 are substantially the same as those in FIG. 7, and thus description thereof is omitted. FIGS. 11 and 12 show the distribution of the required braking forces to the wheels 91, 92, 93, 94 when the FL wheel 91 fails and the braking force becomes 0.

In step S5, the braking control unit 40 determines whether the insufficient braking force of the abnormal braking wheel exceeds the outputtable range of the regenerative braking force. That is, in FIG. 11, it is determined whether the shortage with respect to the required braking force of the FL wheel 91 is larger than the maximum value Frg_max of the regenerative braking force.

When the insufficient braking force is within the outputtable range of the regenerative braking force, it is determined as NO in S5, and the process proceeds to S6. In step S6, the braking control unit 40 controls the normal wheel with the normal braking force and uses the regenerative braking force for the abnormal braking wheel. In FIG. 11, when the brake pedal operation amount is equal to or less than X, the braking force of the FL wheel 91 is covered by using the regenerative braking force as indicated by the solid line.

When the insufficient braking force exceeds the outputtable range of the regenerative braking force, it is determined as YES in S5, and the process proceeds to S7. In step S7, the braking control unit 40 performs adjustment so as to increase the braking force of the normal wheel on the opposite side in the front-rear direction.

When any of the wheels 91 and 92 in the front row is abnormal, the braking control unit 40 drives the wheel drive motor 834 to increase the braking force of the wheel 93, 94 in the rear row. As illustrated in FIG. 12, the braking control unit 40 changes the distribution of the required braking force between the front row and the rear row, within a range in which the vehicle 902 is stable. That is, the braking control unit 40 changes the distribution of the required braking force between the row of the right and left wheels including the abnormal braking wheel and the other row of the right and left wheels. Conversely, when any of the wheels 93 and 94 in the rear row is abnormal, the braking control unit 40 drives the wheel drive motor 812 to increase the braking force of the wheel 91, 92 in the front row.

After step S7, in step S8, the braking control unit 40 determines again whether the insufficient braking force of the abnormal braking wheel exceeds the outputtable range in which the regenerative braking force can be output. When the insufficient braking force is within the outputtable range of the regenerative braking force, it is determined as NO in S8, and the process proceeds to S9. In step S9, the braking control unit 40 controls the normal wheel with the braking force adjusted in step S8, and uses the regenerative braking force for the abnormal braking wheel in the same manner as in step S6.

When the insufficient braking force exceeds the outputtable range of the regenerative braking force, it is determined as YES in S8, and the process proceeds to S10 which is substantially the same as that in FIG. 5. In step 10, the braking control unit 40 performs the yaw moment compensation steering control as in the first embodiment. Here, the steering angle is changed according to the degree of deviation between the actual yaw moment and the required yaw moment.

Further, in step S11, the braking control unit 40 may change the braking force of the conjugate normal wheel according to the degree of deviation between the actual braking force and the required braking force. Specifically, the braking force Fbr2 of the FR wheel 92 may be reduced so that unnecessary yaw does not occur in the state of FIG. 5. In addition, in the flowchart of FIG. 10, the order of the processes to be performed, such as the change in distribution of the braking force between the front row and the rear row and the use of the regenerative braking force, may be changed as appropriate.

As described above, in the abnormal-time braking control of the second embodiment, by combining the generation of the regenerative braking force by the wheel drive motor 812, 834 and the yaw moment compensation steering control by the steering actuator 712, it is possible to perform plural braking controls in a stepwise manner according to the state of the vehicle 902 and the required braking force at the time of abnormality.

In case where it is possible to compensate for the insufficient braking force of the abnormal braking wheel only by using the regenerative braking force or changing the distribution of the braking force between the front row and the rear row, that is, in case where the process ends before proceeding to S10 in the flowchart of FIG. 10, the control of the steering actuator 712 is not executed during the process. Nevertheless, while the control of the steering actuator is included in the steps of the flowchart in advance, it is interpreted that the braking control unit 40 sets the abnormal-time braking control different from the normal control, including at least the control of the steering actuator, so as to suppress the influence on the vehicle behavior due to the abnormality.

### Third Embodiment

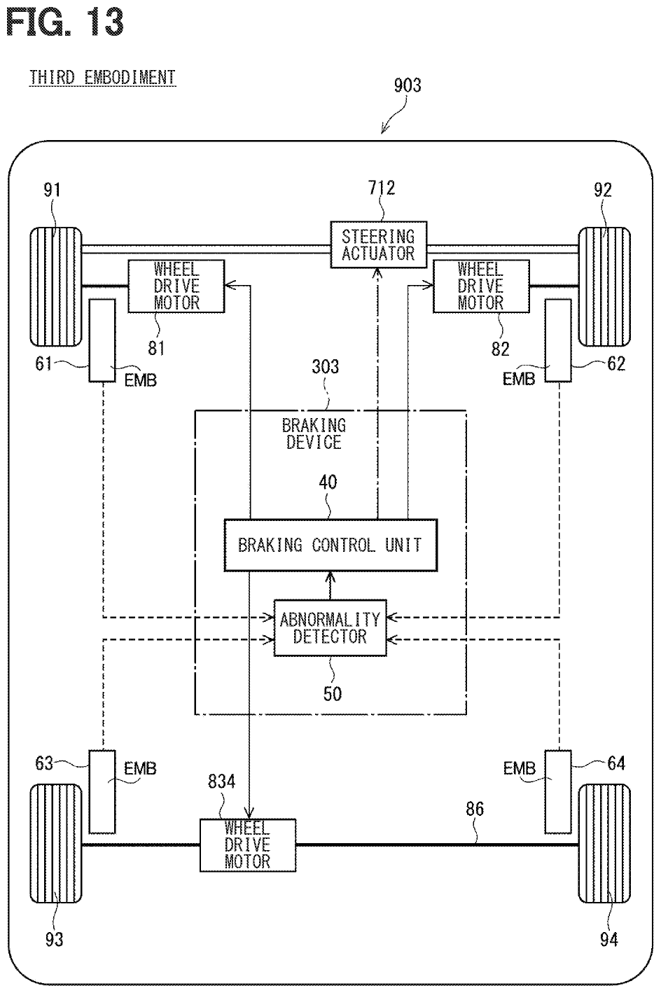

The third embodiment will be described with reference to FIGS. 13 to 15. As shown in FIG. 13, the vehicle 903 including the vehicle braking device 303 of the third embodiment has wheel drive motors 81 and 82 independently provided for the FL wheel 91 and the FR wheel 92, differently from the vehicle 902 of the second embodiment. That is, the third embodiment has a configuration of “front two-wheel independently driven vehicle”. The wheel drive motor 834 is provided for the rear row to commonly drive the RL wheel 93 and the RR wheel 94 as in the second embodiment. The braking control unit 40 of the vehicle braking device 303 controls each operation of the steering actuator 712 and the wheel drive motors 81, 82, 834.

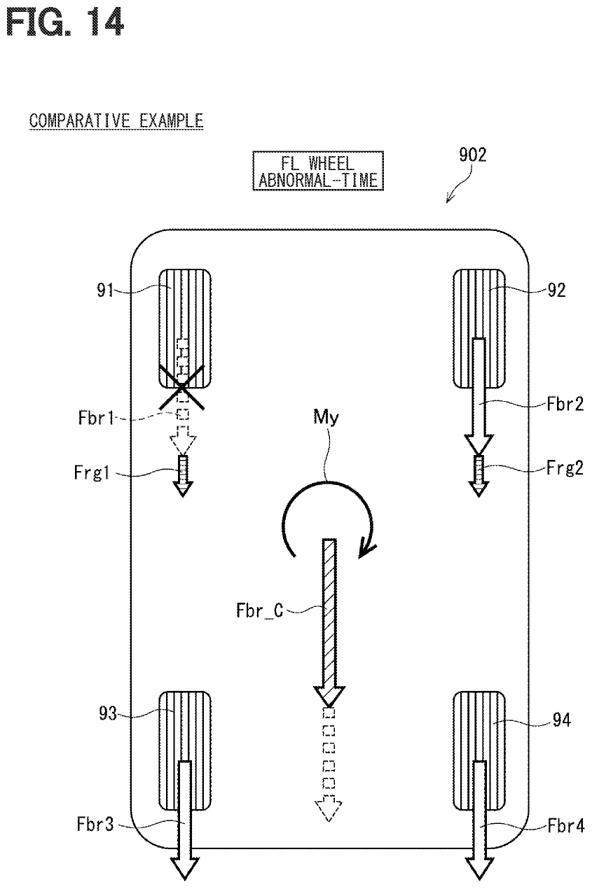

FIG. 14 shows, as a comparative example of the third embodiment, the generation of the braking force by the wheel drive motor 812 in the front two-wheel non-independently driven vehicle in the second embodiment. Here, in order to describe the operation not accompanied by the operation of the steering actuator, the term “abnormal-time braking control” is not used intentionally, and the term “generation of the braking force by the wheel drive motor 812” is described.

In case of the front two-wheel non-independently driven vehicle, when the FL wheel 91 is abnormal, if it is attempted to cover the shortage of the braking force Fbr1 by using the regenerative braking force of the common wheel drive motor 812, it is necessary to apply the regenerative braking force Frg1, Frg2 to the FL wheel 91 and the FR wheel 92 to the same extent. Therefore, it is not possible to reduce the difference in braking force between the FL wheel 91, which is the abnormal braking wheel, and the FR wheel 92, which is the conjugate normal wheel, and unnecessary yaw occurs. In addition, the regenerable amount that is restricted by the battery capacity or the like is consumed on the conjugate normal wheel side, and the regenerable amount on the abnormal braking wheel side is reduced.

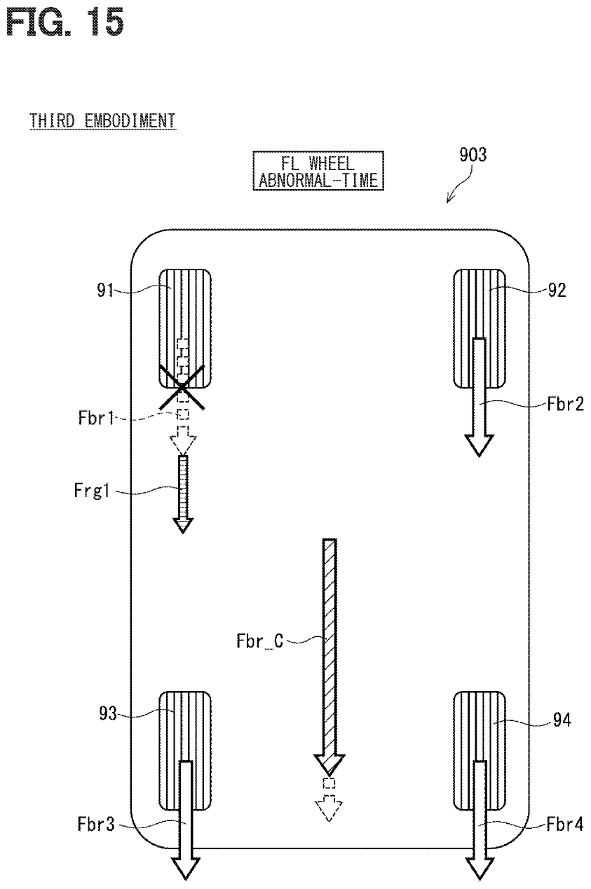

FIG. 15 shows the generation of the braking force by the wheel drive motor 81, 82 in the front two-wheel independently driven vehicle according to the third embodiment. In the third embodiment, since the wheel drive motors 81 and 82 are independently provided, the regenerative braking force Frg1 can be applied only to the FL wheel 91 which is the abnormal braking wheel. Since it is not necessary to apply the regenerative braking force to the FR wheel 92 which is the conjugate normal wheel, it is possible to secure a large regenerable amount of the FL wheel 91 which is the abnormal braking wheel.

### Fourth Embodiment

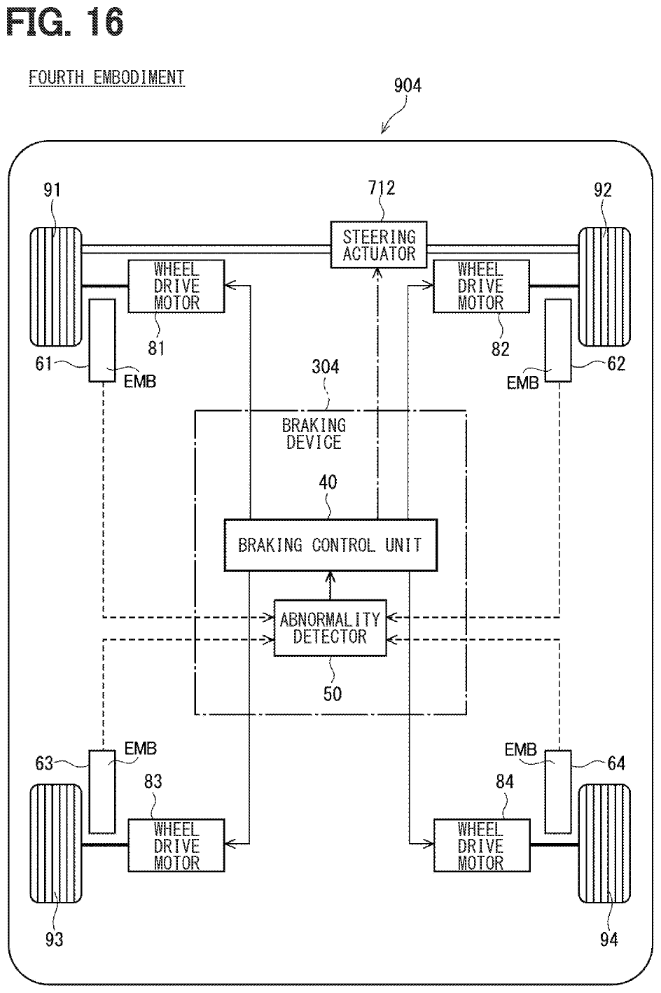

The fourth embodiment will be described with reference to FIG. 16. In the vehicle 904 in which the vehicle braking device 304 of the fourth embodiment is mounted, the wheel drive motors 81, 82, 83, 84 are respectively and independently provided for the wheels 91, 92, 93, 94 of the front row and the rear row with respect to the vehicle 902 of the second embodiment. That is, the fourth embodiment has a configuration of “four-wheel independently driven vehicle”. The braking control unit 40 of the vehicle braking device 304 controls the operation of the steering actuator 712 and each of the wheel drive motors 81, 82, 83, 84.

In the fourth embodiment, the idea of the third embodiment is further applied to the RL wheel 93 and the RR wheel 94 in the rear row. Therefore, it is possible to more effectively use the braking force Fbr1, Fbr2, Fbr3, Fbr4 that can be output by the wheel 91, 92, 93, 94 regardless of the failure location. In addition, the adaptability is high even when plural wheels simultaneously fail, for example, when the FL wheel 91 in the front row and the RR wheel 94 in the rear row simultaneously fail.

### Fifth Embodiment

Next, in the fifth and sixth embodiments, a vehicle braking device is mounted on an independently steered vehicle. In the independently steered vehicle, a steering actuator is provided independently for each wheel relative to at least one pair of right and left wheels in a row, and each wheel can be steered independently. The fifth embodiment shows a configuration in which the vehicle braking device is mounted on a front two-wheel independently steered vehicle, and the sixth embodiment shows a configuration in which the vehicle braking device is mounted on a four-wheel independently steered vehicle.

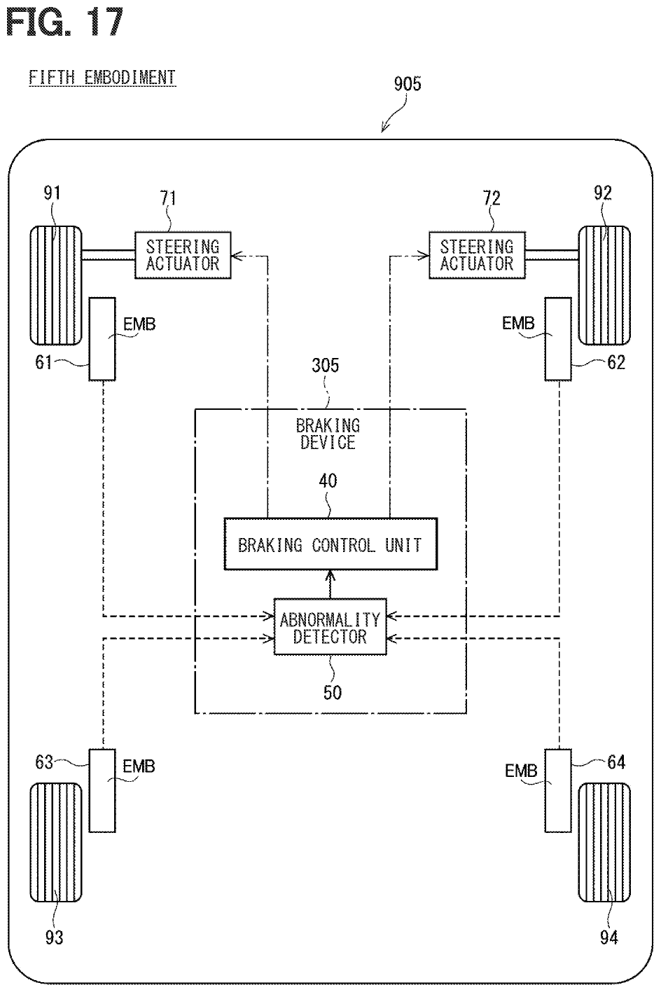

The fifth embodiment will be described with reference to FIGS. 17 to 19. As shown in FIG. 17, in the front two-wheel independently steered vehicle 905 on which the vehicle braking device 305 of the fifth embodiment is mounted, the steering actuators 71 and 72 are independently provided for the FL wheel 91 and the FR wheel 92 in the front row. The braking control unit 40 of the vehicle braking device 304 controls the operation of each of the steering actuators 71 and 72.

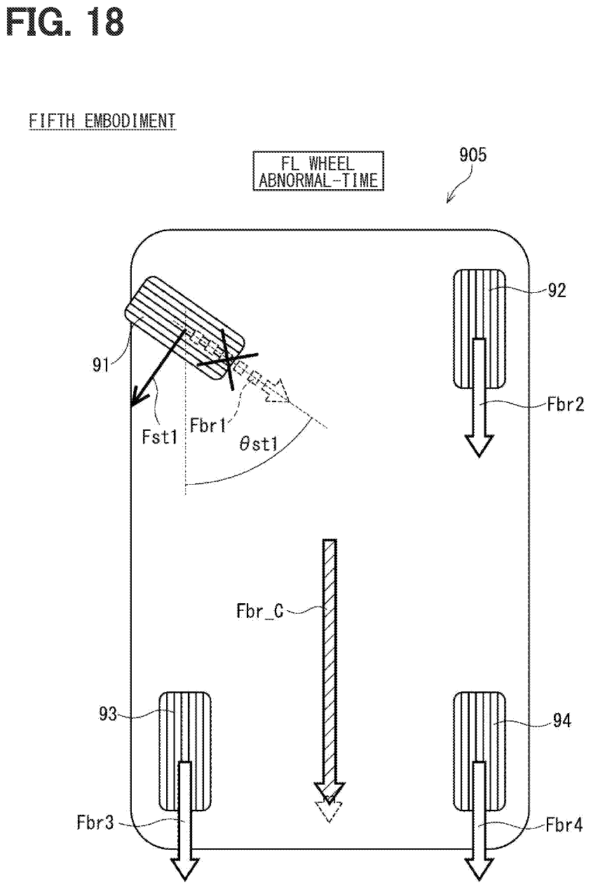

In the first embodiment for the front two-wheel non-independently steered vehicle, as shown in FIG. 5, when the FL wheel 91 is abnormal, it is necessary to collectively steer the FL wheel 91, which is the abnormal braking wheel, and the FR wheel 92, which is the conjugate normal wheel. In contrast, as shown in FIG. 18, in the fifth embodiment, the FR wheel 92, which is the conjugate normal wheel, may not be steered. Accordingly, the steering angle θst1 of the FL wheel 91 can be increased, and the vehicle braking force Fbr_C can be further secured.

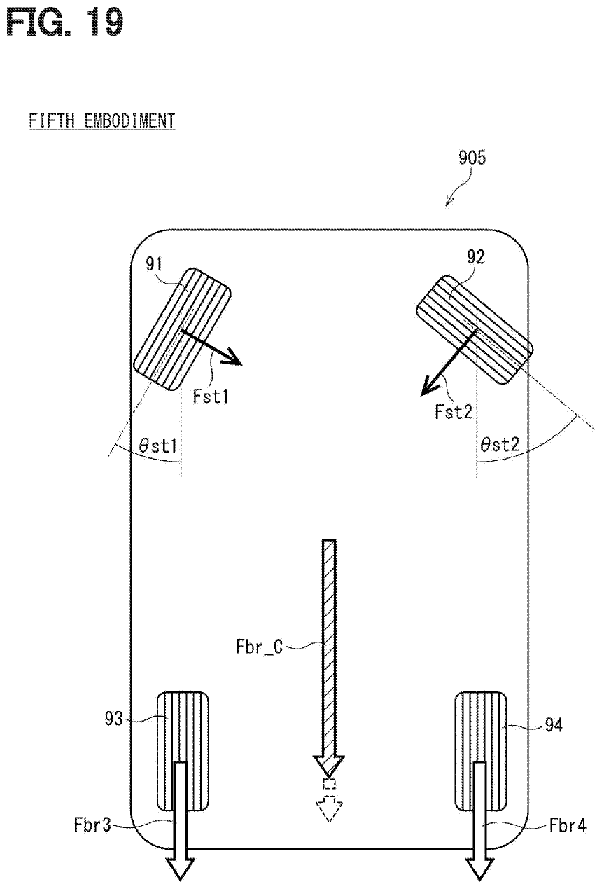

As shown in FIG. 19, in the fifth embodiment, it is possible to steer both the FL wheel 91 and the FR wheel 92 to the toe-in side. Such control is particularly effective when both the FL wheel 91 and the FR wheel 92 fail. It is also possible to turn the vehicle by adjusting the steering angles θst1, θst2 of the wheels 91, 92.

### Sixth Embodiment

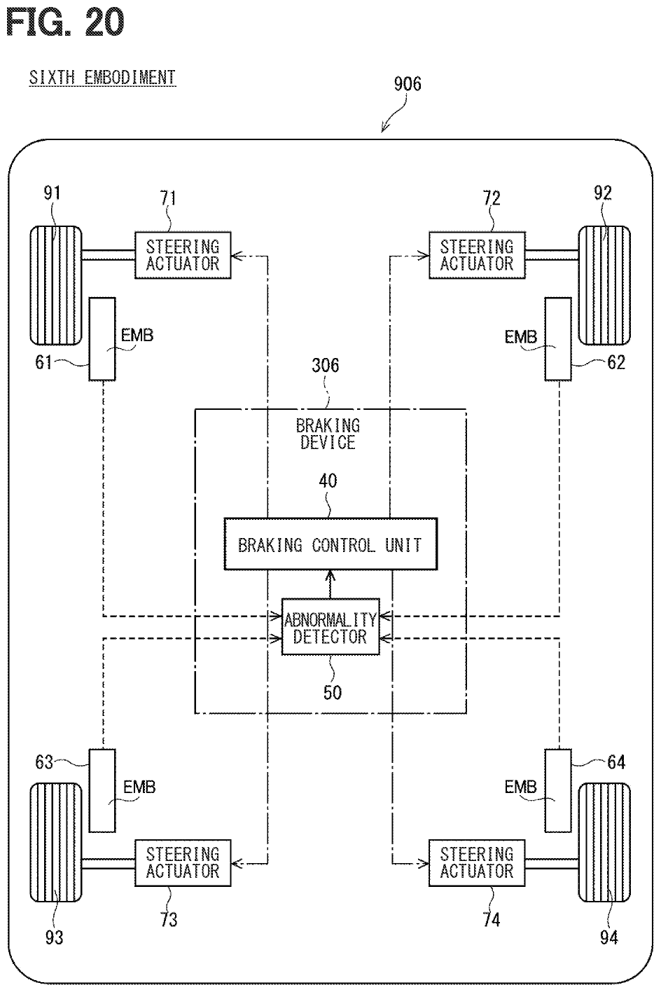

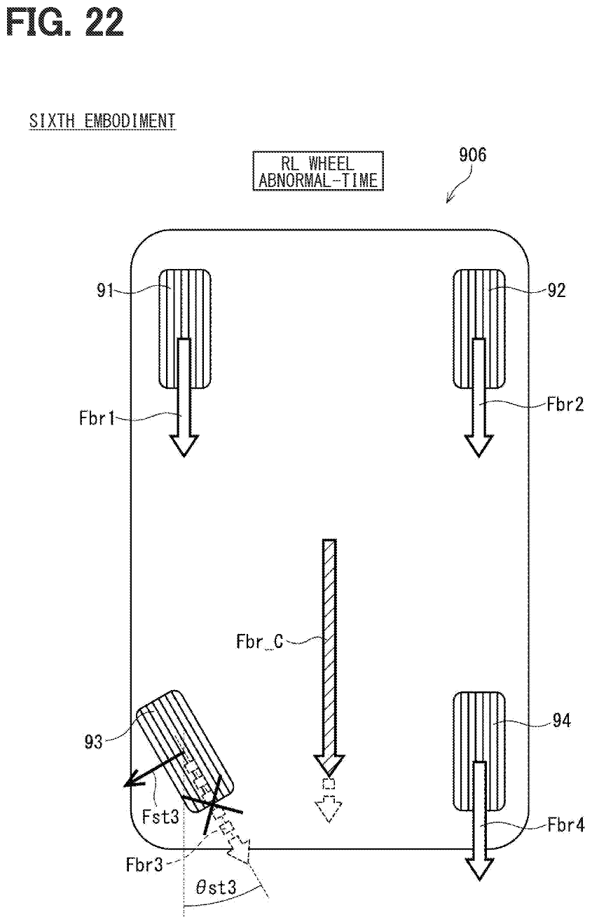

Next, the sixth embodiment will be described with reference to FIGS. 20 to 26. As shown in FIG. 20, in the four-wheel independently steered vehicle 906 on which the vehicle braking device 306 of the sixth embodiment is mounted, the steering actuators 71, 72, 73, 74 are independently provided for the wheels 91, 92, 93, 94. The braking control unit 40 of the vehicle braking device 306 controls the operation of each of the steering actuators 71, 72, 73, 74. In FIGS. 22 to 26, a thick arrow Fst3, Fst4 indicates the steering force, and θst3, θst4 indicates the steering angle.

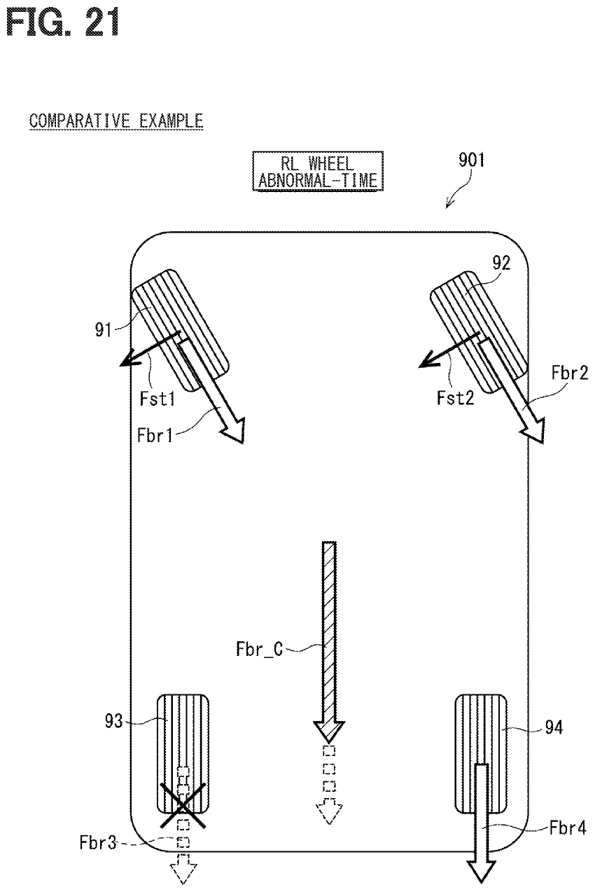

FIG. 21 shows, as a comparative example of the sixth embodiment, a braking control in case where the RL wheel 93 in the rear row fails in the front two-wheel non-independently steered vehicle 901 of the first embodiment. In the first embodiment in which the steering actuator is not provided for the rear row of the vehicle 901, the braking control unit 40 drives the steering actuator 71, 72 corresponding to the FL wheel 91 and the FR wheel 92 in the front row. That is, the steering actuator not corresponding to the abnormal braking wheel is driven to steer the FL wheel 91 and the FR wheel 92 to the left. As a result, the occurrence of yaw can be suppressed.

However, due to the vehicle load distribution applied to the four wheels 91, 92, 93, 94, there is a physical limit to the braking force that can be generated at each wheel, that is, the total braking force of the steering force Fst and the electric brake braking force Fbr. In the comparative example illustrated in FIG. 21, when the RL wheel 93 in the rear row fails, even if the steering force Fst1, Fst2 of the FL wheel 91 and the FR wheel 92 in the front row is utilized or the electric brake braking force Fbr1, Fbr2 is increased, the total braking force cannot be increased to an upper limit or more determined by the load distribution or the like.

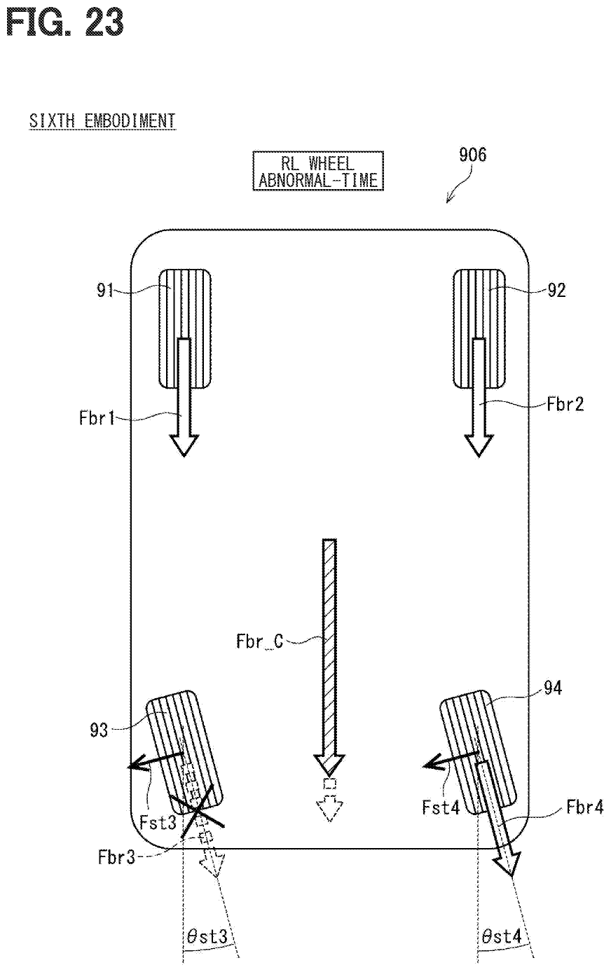

In contrast, as shown in FIG. 22, in the sixth embodiment, it is possible to suppress the occurrence of yaw by driving the steering actuator 73 corresponding to the RL wheel 93 which is the abnormal braking wheel to independently turn only the RL wheel 93. When the RL wheel 93 in the rear row fails, there is a margin in the total brakeable amount of the RL wheel 93 and the RR wheel 94. Therefore, by utilizing the turning force Fst3 of the RL wheel 93, the total braking force Fbr_C of the vehicle can be made larger than that in the comparative example of FIG. 21. Alternatively, as illustrated in FIG. 23, the braking control unit 40 can suppress the occurrence of yaw by driving the steering actuator 73, 74 to turn the RL wheel 93 and the RR wheel 94 together.

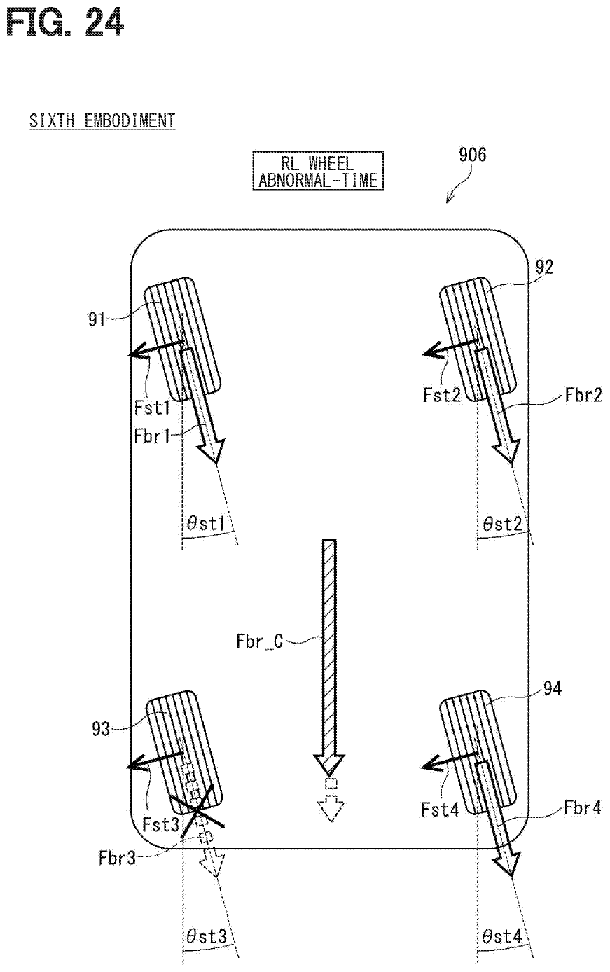

FIGS. 24 to 26 illustrate another braking control example in the four-wheel independently steered vehicle 905. In the example of FIG. 24, when the RL wheel 93 is abnormal, the braking control unit 40 steers all of the four wheels 91, 92, 93, 94 to the left by the operations of the four steering actuators 71, 72, 73, 74. The steering angles θst1, θst2, θst3, and θst4 of the wheels are set to relatively small angles equal to each other. This makes it possible to more fully utilize each brakeable amount of the four wheels, regardless of the failure location.

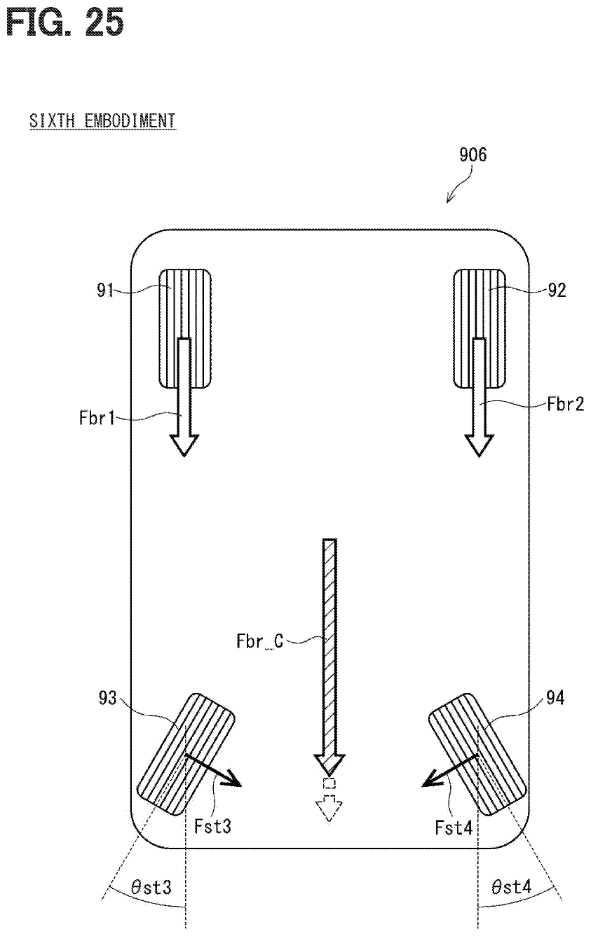

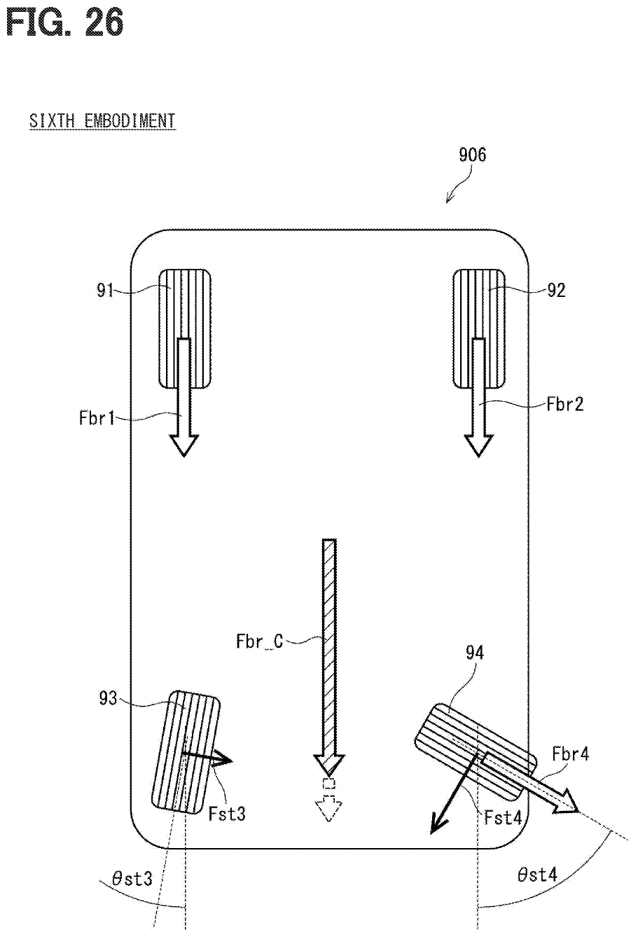

In the examples of FIGS. 25 and 26, both the RL wheel 93 and the RR wheel 94 are steered to the toe-in side. In the example of FIG. 25, it is assumed that both the RL wheel 93 and the RR wheel 94 fail, and the steering angles θst3 and θst4 of the RL wheel 93 and the RR wheel 94 are set to be substantially the same. In the example of FIG. 26, it is assumed that the RL wheel 93 fails and the RR wheel 94 is normal, and the steering angle θst3 of the RL wheel 93 is set to be relatively small and the steering angle θst4 of the RR wheel 94 is set to be relatively large.

### Other Embodiments

(a) The vehicle on which the vehicle braking device of the present disclosure is mounted is not limited to a four-wheel vehicle having two rows of right and left wheels in the vehicle front-rear direction, and may be a vehicle having six or more wheels having three or more rows of wheels in the vehicle front-rear direction. In this case, the configuration of the four-wheel independently driven vehicle according to the fourth embodiment is extended to the configuration of the all-wheel independently driven vehicle. That is, the wheel drive motor is provided independently for each of the wheels. Further, the configuration of the four-wheel independently steered vehicle according to the sixth embodiment is extended to the configuration of the all-wheel independently steered vehicle. That is, the steering actuator is provided independently for each of the wheels.
(b) The braking force of the abnormal braking wheel and the braking force of the normal wheel may be changed by means other than the electric brake 61, 62, 63, 64 in the abnormal-time braking control, without being limited to the wheel drive motor according to the second to fourth embodiments. The braking force of the abnormal braking wheel and the braking force of the normal wheel may be changed by an engine brake or the like of an engine vehicle. In this case, a mechanism capable of changing the distribution of the braking force between the two wheels in the front row and the two wheels in the rear row of the vehicle may be provided.
(c) The independently steered vehicle of the fifth and sixth embodiments may further include a wheel drive motor. As a result, it is possible to perform more various abnormal-time braking control according to the failure situation of each wheel. In case where the independently steered vehicle and the independently driven wheels are combined, the braking force for each wheel can be appropriately controlled in accordance with the required braking force even when any wheel fails.
(d) In the abnormal-time braking control of the above embodiment, as the influence on the vehicle behavior due to the abnormality of the electric brake, the generation of the yaw moment different from the required yaw moment is mainly focused. However, as an influence on the vehicle behavior other than the yaw, the abnormal-time braking control may be performed so as to suppress the occurrence of roll or pitch.

The present disclosure should not be limited to the embodiment described above. Various other embodiments may be implemented without departing from the scope of the present disclosure.

The braking control unit and method described in the present disclosure may be implemented by a special purpose computer which is configured with a memory and a processor programmed to execute one or more particular functions embodied in computer programs of the memory. Alternatively, the braking control unit described in the present disclosure and the method thereof may be realized by a dedicated computer configured as a processor with one or more dedicated hardware logic circuits. Alternatively, the braking control unit and method described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as an instruction executed by a computer.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A braking device for a vehicle having two or more rows of right and left wheels, a plurality of electric brakes to generate braking forces on the wheels respectively, and at least one steering actuator capable of turning at least one row of the right and left wheels regardless of a steering wheel operation, the braking device comprising:
a braking control unit configured to control a braking force of the electric brake for each of the wheels and an operation of the steering actuator; and
an abnormality detector configured to detect an abnormality in the electric brakes, wherein
when the abnormality detector detects an abnormality in the electric brakes, the braking control unit switches to an abnormal-time braking control different from a normal state control, at least controlling the steering actuator, so as to suppress an influence on the vehicle caused by the abnormality,
an abnormal wheel is defined to correspond to the electric brake in which the abnormality is detected, of the right and left wheels, and a conjugate normal wheel is the other of the right and left wheels to correspond the electric brake which is normal, and
in the abnormal-time braking control, the braking control unit is configured to drive the at least one steering actuator so as to reduce a difference between an actual yaw moment, which is generated by a difference in braking force between the abnormal wheel and the conjugate normal wheel, and a required yaw moment required for the vehicle.

2. The braking device according to claim 1, wherein the braking control unit drives the steering actuator corresponding to at least the abnormal wheel in the abnormal-time braking control.

3. The braking device according to claim 1, wherein the braking control unit further changes a braking force for a normal wheel in the abnormal-time braking control.

4. The braking device according to claim 3, wherein
in the abnormal-time braking control, the braking control unit changes a distribution of a required braking force between one row of the right and left wheels including the abnormal wheel and the other row of the right and left wheels.

5. The braking device according to claim 1, wherein
the vehicle further has a wheel drive motor to drive each of the wheels, and
in the abnormal-time braking control, the braking control unit is configured to generate the braking force by switching energization to the wheel drive motor corresponding to at least the abnormal wheel, so as to generate a regenerative torque to suppress rotation of the wheel or a counter torque to rotate the wheel in a direction opposite to a traveling direction of the vehicle.

6. A braking device for a vehicle having two or more rows of right and left wheels, a plurality of electric brakes to generate braking forces on the wheels respectively, and at least one steering actuator capable of turning at least one row of the right and left wheels regardless of a steering wheel operation, the braking device comprising:
a braking control unit configured to control a braking force of the electric brake for each of the wheels and an operation of the steering actuator; and
an abnormality detector configured to detect an abnormality in the electric brakes, wherein
when the abnormality detector detects an abnormality in the electric brakes, the braking control unit switches to an abnormal-time braking control different from a normal state control, at least controlling the steering actuator, so as to suppress an influence on the vehicle caused by the abnormality,
the vehicle further has a wheel drive motor for driving each of the wheels, and
in the abnormal-time braking control, the braking control unit is configured to generate the braking force by switching energization to the wheel drive motor corresponding to at least the abnormal wheel, so as to generate a regenerative torque to suppress rotation of the wheel or a counter torque to rotate the wheel in a direction opposite to a traveling direction of the vehicle.

7. The braking device according to claim 6, wherein the wheel drive motor is provided independently for each of at least one row of the right and left wheels.

8. The braking device according to claim 7, wherein the wheel drive motor is provided independently for all of the wheels.

9. The braking device according to claim 6, wherein the steering actuator is provided independently for each of at least one row of the right and left wheels.

10. The braking device according to claim 9, wherein the steering actuator is provided independently for all of the wheels.
